(19) United States
(12) Patent Application Publication
(10) Pub. No.: US 2025/0191077 A1
(43) Pub. Date: Jun. 12, 2025

(54) PROCESS OF CONTROL BY A SCHOOL OF ITS REVENUE SHARING OF SCHOOL SPORTS REVENUE WITH SCHOOL STUDENT ATHLETES, SAID IMPROVING COMPRISING CASH BACK FUNDING COMPRISING USE OF AN ALGORITHM COMPRISING A SCHOOL DESIGNATED CONTROL FACTOR, AND WHEREBY ELIGIBLE SEASON TICKET HOLDERS ARE ALLOWED TO RECEIVE CASH BACK FOR ELIGIBLE PURCHASES AT A PARTICIPATING ONLINE PLATFORM WHEREIN GOODS MARKED WITH STUDENT ATHLETES NAMES, IMAGES, AND/OR LIKENESSES (NIL) ARE SOLD

(71) Applicant: James E. BEECHAM, West Palm Beach, FL (US)

(72) Inventor: James E. BEECHAM, West Palm Beach, FL (US)

(21) Appl. No.: 18/611,316

(22) Filed: Mar. 20, 2024

Related U.S. Application Data
(63) Continuation-in-part of application No. 18/534,662, filed on Dec. 10, 2023, now Pat. No. 11,954,660.

(51) Int. Cl. G06Q 40/12

(52) U.S. Cl. CPC G06Q 40/12; G06Q 20/102

(57) ABSTRACT

This invention presents a method and system for improving the process of control by a school of the sharing of said school's sports revenue with said school's student athletes. Said improving comprises the use of an algorithm which comprises at least one school-designated control factor, said algorithm used to determine the amount of cash-back eligibility for at least one school season ticket holder (STH). Said algorithm computes a running remainder of eligibility by which said STH's purchases, at an online platform selling NIL-marked goods, are judged as to eligibility for cash-back. Said cash-back eligible purchase amounts are reimbursed to said STH by corresponding debits from said school's account. Said eligible purchases provide financial benefits to said student athletes whose NIL-marks are on said goods which STH purchases.

### CROSS-REFERENCE TO RELATED PATENT

This U.S. patent application is a Continuation-In-Part of U.S. patent application Ser. No. 18/534,662.

### 1. FIELD OF THE INVENTION

The present invention relates to school control of the sharing of revenue from school sports. More specifically, instant invention method and system relates to improving the process of school control of school sports revenue-sharing with school's student athletes, said control comprising use of an algorithm comprising a school-provided factor, said process comprising assisting eligible season ticket holders to receive cash-back in association to online platform purchases of NIL goods.

### BACKGROUND OF THE INVENTION

In the current era of name, image, and likeness (NIL), student athletes in high schools and colleges in the USA have an opportunity to earn money associated to licenses, endorsements, and sales of goods comprising said athletes' names, images, and likenesses (NIL). However, some of the student athletes find such NIL earnings to be less beneficial than what money they think could be obtained by said student athletes voting to unionize and then threatening to go on strike and withhold their school-sports-playing labor to obtain concessions from schools such as a sizable share of revenue from the lucrative school sports. To support their attempt to unionize, the school athletes claim to be employees of the school, and not without justification. The schools conversely argue that these scholarship student athletes are not true employees of the school. Furthermore, the schools argue that paying a large share of revenue, as might be forced under threat of athletes going on strike, that large sharing of revenue circumstance could suddenly remove money from the school's budget which otherwise would have been available to support the many ‘non-lucrative’ sports also sponsored by scholarships at the school. What is needed is a method and system to assist said schools in controlling said revenue-sharing, said control arranged in such a manner as to avoid the sudden financial crisis possible with strikes, while also avoiding the associated unhappiness of fans who believe the student athletes deserve more money. Instant invention provides at least a partial solution comprising the use of a cash-back algorithm comprising a school-determined factor, said cash-back paid as reimbursement to season ticket holders (STHs) for purchases these STHs make at a participating online platform for NIL sale of goods.

### BRIEF DESCRIPTION OF THE INVENTION

In a preferred embodiment, instant invention comprises a method and system for improving the process of control by a school of its revenue-sharing with student athletes of said school's sports revenue, said system comprising use of an algorithm comprising a control factor determined by said school, said algorithm comprising calculating for at least one season ticket holder (STH) of said school's sports program, an eligibility for cash-back payments for purchases said STH makes at a participating online platform, said platform selling name, image, and likeness (NIL) marked goods, said marks of student athletes, said purchases' eligibility calculated as a running remainder via the algorithm, said eligible purchases reimbursed as cash-back to said STH's account funded by a corresponding debit from a school-funded account, said purchases leading to monies paid within said participating online platform to be at least partially dispersed to said student athletes chosen by said STH by virtue of said goods purchased by said STH being marked by NIL of said student athletes.

In a preferred embodiment, instant invention system further comprises a display of elements of said accounting arranged to be visible to the sports fan crowd attending said event. Such display visibility will provide evidence of revenue sharing by said school with said student athletes, such as where the display is on the scoreboard of the sports arena. Said awareness by the fans accrues to the benefit of the school because the fans generally believe that the student athletes deserve a share of sports revenue.

In a preferred embodiment, instant invention system further comprises a display of elements of said accounting arranged to be visible to the recruiters of the school, such recruiters thus able to share said data with potential recruits. Such a display by recruiters to potential recruits can accrue to the benefit of the school because more talented athletes tend to follow the money in this era of NIL.

In a preferred embodiment, instant invention system further comprises a display of elements of said accounting arranged to be visible to the politicians and regulators of relevance to the issue of governing/regulating NIL. Such a display can accrue to the benefit of the school by influencing said politicians and regulators to see controlled revenue-sharing as a feasible long-term solution.

In a preferred embodiment, instant invention system further comprises a display of elements of said system operations in media, such as the advertising broadcast when said school's sports are played. Such a display can accrue to the benefit of the school when other schools understand and join in the system.

In a preferred embodiment, instant invention system further comprises a service provided by student athlete in association to said student athlete's name, image, and/or likeness. Where such service is as host of an online chat, and where said chat is on a video share system such as Zoom, and where the chat set display highlights the controlled revenue-sharing as successful for that student athlete, said display can accrue to the benefit of said school.

In a preferred embodiment, instant invention system further comprises opportunity for cash-back payments to eligible STHs to rise in dollar amount in subsequent years, such as when the program wins at the sports and experiences increased popularity of the fan base. Such a development can be part of a notice to the next season's prospective ticket purchasers and thus accrue to the benefit of the school and the revenue-sharing student athletes.

In a preferred embodiment, instant invention system further comprises school marks on NIL goods sold within said online platform. The association of fan knowledge of satisfactory revenue-sharing by said school can accrue to improved sales of said schools marked goods, earning additional money for the school under IP license terms.

Other features and advantages of the present invention will become apparent when the following detailed description is read in conjunction with the accompanying drawings, in which:

### BRIEF DESCRIPTION OF THE FIGURES

FIG. 1 is a flow diagram comprising a cash-back algorithm of a preferred embodiment.

### DETAILED DESCRIPTION OF PREFERRED EMBODIMENTS

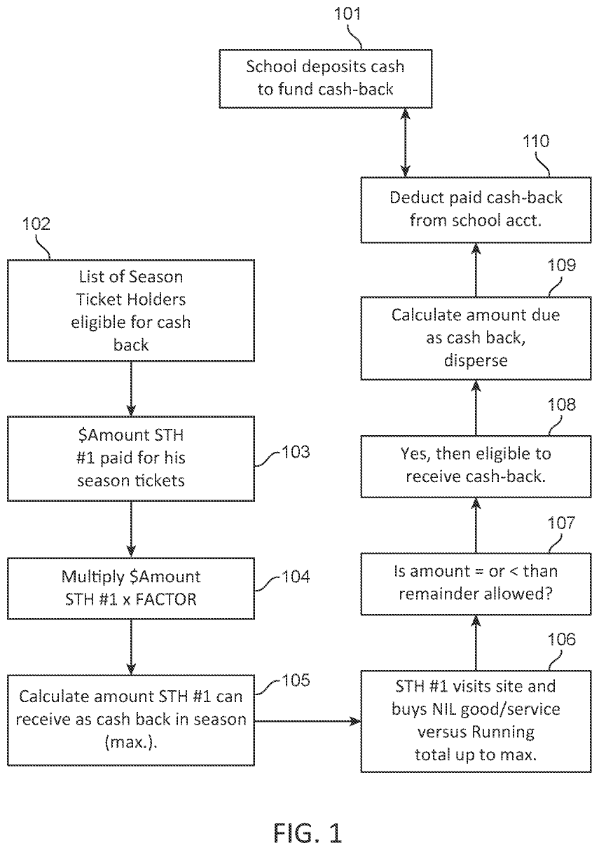

In FIG. 1, at top is a step 101 wherein a school deposits cash into an account, such account providing funds to pay for cash-back benefits for participating eligible season ticket holders. In the top box at left 102 is a notation that mentions a list of season ticket holders (STHs) who have paid for their school sports event tickets, said list typically provided in a spreadsheet format to system's use, said spreadsheet typically having also the dollar amounts each STH paid. In the next step 103, the dollar amount paid for his season tickets by a specific STH, STH #1, is indicated and then in step 104 said payment amount for season tickets is multiplied by a school-determined control FACTOR to yield 105 the maximum benefit in dollars which the STH #1 can receive during his eligibility period this season as cash-back. Such a control factor from the school can typically be in the range of ten (10%) percent or up to fifty (50%) percent. This factor is used in algorithm, being multiplied by the dollar amount paid by each season ticket holder to define for each STH his or her maximum benefit or starting eligibility within the cash-back program. If the school has another large revenue source from the lucrative sports at the school, i.e., from other than season ticket sales, for example from broadcast rights for example associated to said lucrative sports games, then the school could afford to choose or set a higher control factor to apply to the algorithm multiplication times each STH amount paid for season tickets in determining cash-back maximums. The total amount of cash-back awarded each season by the school, that amount is something the school is likely to want to be known as substantial. That is because if it is a substantial amount, that fact could be publicized to help the school politically or for recruiting or if the school so chooses for justifying a delay in the union efforts of student athletes. In the next step 106, the STH #1 visits the online platform of the system to make a purchase of a good or service associated to or marked with NIL of an athlete, said athlete as selected by said STH #1. Such amount of purchase is evaluated against a running eligibility remainder as calculated with each purchase. In other words, the amount the STH #1 spends will be refunded as cash-back up to the maximum allowed as determined per the control FACTOR multiplication step 105. Thus, if the STH #1 made a purchase yesterday, then that amount has already been subtracted from the running total of remaining cash-back benefits currently available. In the next step 107, the system compares the amount of the present purchase to the remainder allowed under the running total. Where the amount is fully eligible 108 for cash-back, then in the next steps 109 the system receives the money for said purchase by said STH #1, logs the amount against the running total to reduce it to the correct remainder allowed post said purchase, then the system debits 110 the amount allowed in this purchase from the school account and credits that amount to STH 1's account as cash-back. In the circumstance where a purchase is only partially eligible, then that eligible part only is paid to STH #1 as cash-back, that eligible amount only being debited from the school account, and the ‘remainder allowed’ is calculated post said purchase to be zero remaining, i.e., no addition cash-back allowed for the season for that STH. Where a remainder is present after the conclusion of the season, the school may choose to credit that remainder amount for the STH #1 for his use in the following season.

In a preferred embodiment, in general terms, the algorithm operation can be described as follows: The participating school computes a Control Factor, based on the revenue-sharing GOAL the school has set. The Control Factor is determined as the GOAL in dollars divided by the amount total of season ticket sale dollars received by that school. Then the school allocates that GOAL amount in dollars to the cash-back school account (101 in FIG. 1). Then the school supplies the system with the Control Factor (10% in this example) and the spreadsheet listing each STH and respective dollar amount each paid for his season tickets. Then school gives authorization to the system to debit the school account per the agreed operation of the cash-back algorithm (see FIG. 1).

In a preferred embodiment, the algorithm can be characterized in a more mathematical format from the perspective of each STH by the following example:

Where STH #1 spent $1000 on season tickets, and where the control FACTOR set by the school is ten (10%) percent, then the starting eligible amount for STH #1's cash-back eligibility is calculated as follows:

$1000 (STH expenditure for season tickets)×0.10(school set control factor)=$100(maximum cash-back eligibility for this STH).

Furthermore, where said STH #1 is assigned ID #000001, and wherein during his period of eligibility said STH #1 enters said ID # at a participating online platform selling NIL goods, and STH #1 makes an initial online purchase of said NIL marked goods for $40, then the calculation of running remainder is as follows:
$40 is less than $100, thus the purchase is fully eligible, and the running remainder is calculated as $100−$40=$60, and thus a cash-back $40 is credited to account of STH #1, and a debit of $40 from the school account is credited to the platform to the benefit of the said student athlete associated to said NIL-marked goods.

Then where said SHT #1, again within his period of eligibility, visits the said participating online platform a week later, enters his ID #, and makes a purchase of NIL-marked goods of a second athlete for $30, the algorithm calculates $30 is less than $60 (the running remainder at that time), thus the purchase is fully eligible, and the running remainder is calculated as follows:
$60−$30=$30, and thus a cash-back of $30 is credited to account of STH #1, and a debit of $30 from the school account is credited to the platform for the benefit of the said second student athlete.

Then, where said SHT #1, again within his period of eligibility, visits the said participating online platform a further week later, enters his ID #, and makes a purchase of $50 for NIL-marked goods related to a third student athlete, the algorithm calculates as follows:
$50 is greater than running remainder at that point $30, greater by $20, thus $50−$20=$30 eligible of $50 purchase, and thus a cash-back of $30 is credited to account of STH #1, and a debit of $30 from the school account is credited to the platform for the benefit of the said third student athlete, and wherein said STH #1's running remainder is calculated as $30−$30=0, i.e., zeroed out, then the system records that STH #1's cash-back benefits for the season are zeroed out and he has no further eligibility.

For the accounting of the School making the funds available for cash-back (FIG. 1, 101) as herein described, these debits described in the above example ($40 debit, $30 debit, $30 debit), these are viewed as sharing of sports revenue derived from school's sports program revenue and shared by virtue of cash-back reimbursement of STH's payments online for NIL-marked goods, said online payments accruing at least in part to accounts of the NIL-marks-associated student athletes. The athletes eligible for said cash-back money are typically those athletes who play sports for said school, such as those listed by athlete's name and athlete's online platform ID #, said listing on the school's spreadsheet provided to administration as herein disclosed for use in instant invention method and system. Said spreadsheet further serves as documentation that said athletes are eligible and approved by said school for participation in said school's funding of instant invention cash-back program. Thus, the school can use said accounting as evidence of said school's revenue-sharing, such use promoting the school's reputation, as in ads visible to fans, ads for use by recruiters seeking to interest recruits to enroll at the school and play sports at the school.

It is likely that the school, via said Control Factor setting of ten percent, said school might be judged by the school's fan base as having exercised rather stingy control over the amount of sports revenue school has chosen to share with student athletes that season. Where fans and the student athletes believe a greater share should be made available, they may petition the school administration to accomplish said greater sharing. Meanwhile, a sharing of data from school to school regarding the level of Control Factor at various schools, and a sharing of data from student athlete to student athlete regarding the amount of resulting earnings experienced by said school's student athletes, said data will become known. Such data sharing can be expected to influence the actions of fans, student athletes, and school administration in future decisions tending to more generous sharing. Furthermore, the eligible purchases by STHs will familiarize them with the online platform, and likely lead the STHs to make additional purchases to the benefit of the student athletes, even after the STHs eligibility within cash-back has zeroed out.

Although the invention has been described in considerable detail in language specific to structural features, and or method acts, it is to be understood that the invention specific to structural features, and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated and can be made without departing from the spirit and scope of the invention. For example, the improving of the process of control for the school regarding the school's sports revenue-sharing with their student athletes as herein disclosed by use of instant invention, such improving by use of the disclosed algorithm comprising a school-designated control factor, and further associated to a purchase mechanism by participating fans that funds student athletes, use of instant invention is also envisioned similarly applicable when comprising use of coupons and/or discount codes or loyalty points or other similar well-known market mechanisms of commerce. In another example, the spreadsheet from the school can comprise addition information, for example a list of eligible athletes who may receive monies if their NIL-marked goods are eligibly selected for purchase on the online platform by one of the said eligible STHs of said school. In this manner, the school may designate, for example, all athletes registered and playing any of the sports at their school, not just the lucrative sports. In this manner, the cash-back eligibility for STH only would apply where eligible STH on said school's spreadsheet with sufficient remainder selects to purchase NIL marked goods at the participating online platform where the ID number of said NIL marking student athlete also appears on the spreadsheet, i.e., as a match to one of the school's designated group of eligible student athlete recipients, i.e., a student athlete of school designated eligible for a share of said school's cash back monies if his or her marked goods so purchased.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

What is claimed is:

1-10 (canceled)

11. A method for improving the process of control by a school of said school's sports revenue-sharing with student athletes of said school, said method comprising steps:
compiling a list of season ticket holders STH, and
assigning each STH a dollar amount comprising amount each respectively paid for season tickets, and
assigning an identification number to each such STH, and
applying an algorithm to said data, said algorithm comprising use of a control factor determined by said school, and
calculating a starting eligibility for each STH as to cash-back, and
calculating a running remainder for each STH as he or she makes eligible purchases, and
providing said eligible STHs with cash-back on eligible purchases as calculations verify eligibility, and
debiting in correspondence to said provided cash-back payments, said debits from an account funded by said school, and
dispersing at online platform which sells NIL-marked goods, money to student athletes linked by said NIL marks to said eligible purchases.

12. The method of claim 11, further comprising the step of using a period of eligibility.

13. The method of claim 11, further comprising the step of using a starting eligibility.

14. The method of claim 11, further comprising the step of using a control factor in the range of ten (10%) percent to fifty (50%) percent.

15. The method of claim 11, further comprising the step of displaying an accounting of cash-back on a scoreboard of the school.

16. The method of claim 11, further comprising the step of displaying at least a reference to cash-back by a recruiter.

17. The method of claim 11, further comprising the step of displaying at least a reference to cash-back on a broadcast of school sports play.

18. The method of claim 11, further comprising the step of displaying at least a reference to cash-back on a video chat.

19. The method of claim 11, further comprising the step of providing a notice to prospective purchasers of said school's sports tickets.

20. The method of claim 19, further comprising the step of displaying in said notice at least a reference to cash-back.

21. A method for improving the process of control by a school of said school's sports-revenue-sharing with student athletes of said school, said method comprising steps:
assigning at least one sports-event ticket holder an eligibility to receive cash-back, and providing said eligible ticket holder with cash-back on at least one purchase by said ticket holder of at least one student athlete's name, image, or likeness (NIL) marked good;
debiting from an account funded by said school which issued said sports-event ticket, said debiting in correspondence to said cash-back payment to said ticket holder; and,
dispersing money to at least one student athlete of said school in association to sale of said at least one student athlete's NIL marked good for which said cash-back payment was authorized.

22. The method of claim 21, further comprising the step of using an algorithm.

23. The method of claim 21, further comprising the step of using a control factor.

24. The method of claim 21, further comprising the step of using an online platform.

25. The method of claim 21, further comprising the step of using a list of season ticket holders.

26. The method of claim 21, further comprising the step of assigning an identification number to at least one ticket holder.

27. The method of claim 21, further comprising the step of displaying to the public an accounting comprised of data at least referencing cash-back payments.

28. The method of claim 21, further comprising the step of using by a recruiter of at least a reference to cash-back.

29. The method of claim 21, further comprising the step of at least referencing cash-back in a broadcast of a sports event.

30. The method of claim 21, further comprising the step of sending a notice comprising at least a reference to cash-back payments.
